(19) United States
(12) Patent Application Publication
(10) Pub. No.: US 2013/0063926 A1
(43) Pub. Date: Mar. 14, 2013

(54) PHOSPHORS

(71) Applicants: Holger Winkler, Darmstadt (DE); Andreas Benker, Lautertal (DE); Ralf Petry, Griesheim (DE); Tim Vosgroene, Ober-Ramstadt (DE)

(72) Inventors: Holger Winkler, Darmstadt (DE); Andreas Benker, Lautertal (DE); Ralf Petry, Griesheim (DE); Tim Vosgroene, Ober-Ramstadt (DE)

(73) Assignee: MERCK PATENT GESELLSCHAFT MIT BESCHRANKTER HAFTUNG, DARMSTADT (DE)

(21) Appl. No.: 13/699,069

(22) PCT Filed: Apr. 26, 2011
(86) PCT No.: PCT/EP2011/002084

§ 371 Date: Nov. 20, 2012

(30) Foreign Application Priority Data
May 22, 2010 (DE) 10 2010 021 341.1

(51) Int. Cl. C09K 11/80; C09K 11/84; C09K 11/86; F21V 9/16

(52) U.S. Cl. 362/84; 252/301.4 R; 252/301.4 F; 252/301.4 S; 252/301.4 H

(57) ABSTRACT

The invention relates to mixtures comprising at least one phosphor of the formula I,

AₐLu_{c},CeₓAlₗ,GaₘO₁₂ (I)

and at least one red-emitting phosphor, to a corresponding process for the preparation of these mixtures, and to the use thereof as conversion phosphors.

The invention relates to phosphor mixtures, to a process for the preparation of these mixtures, and to the use thereof as conversion phosphors or in lamps.

LEDs are increasing in importance—both as lighting and also on use as backlighting in liquid-crystal displays (LC displays). These novel light sources have a number of advantages over conventional cold-cathode fluorescent lamps (CCFLs), such as a longer lifetime, potential energy saving, absence of harmful contents (such as mercury in CCFLs).

In the past, for example, arrangements of LEDs which emit blue, green and red light have been employed as backlighting source for LC TV applications. However, this multichip approach has some disadvantages: it is extremely difficult to combine three different chip materials and to ensure uniformity and stability of the light parameters, such as colour point.

pcLEDs (phosphor converted LEDs) have therefore been introduced as light sources for use as backlighting. These usually comprise a green phosphor and a deep-red phosphor together with the blue light emission of an LED chip, which are balanced in accordance with the transmission spectra of the colour filter (transmission bands in the blue, green and red region of the spectrum). Theoretically, a construction of this type facilitates colour spaces which are much larger than the usual sRGB. Owing to bottlenecks in the availability of suitable qualities, there is still a demand for further optimised phosphors and/or phosphor mixtures.

Surprisingly, it has now been found that certain phosphor combinations give rise to good LED qualities even when employed in comparatively small amounts.

A first embodiment of the present invention is therefore a mixture comprising at least one phosphor of the formula I,

AₐLu_{c},CeₓAlₗ,GaₘO₁₂ (I)

where
A stands for one or more elements selected from Y, Gd, Se, Sm, Tb, Pr, Th, Ir, Sb, Bi, and
a stands for a value from the range from 0 to 2.895 and
c stands for a value from the range from 0.1 to 2.995 and
x stands for a value from the range from 0.005 to 1 and
where a, c and x are selected so that a+c+x=3, and
I stands for a value from the range from 0 to 4.99 and
m stands for a value from the range from 0.01 to 5, where I and m are selected so that I+m=5, and
at least one red-emitting phosphor.

Mixtures according to the invention give rise to good LED qualities even when employed in small amounts. On use of preferred mixtures, the phosphor amounts, in particular of red phosphors, can even be reduced compared with the prior art for the same LED quality, or the LED quality can be increased if the usual amounts are employed. The LED quality is described here via conventional parameters, such as, for example, the colour rendering index, the correlated colour temperature, lumen equivalent or absolute lumen, or the colour point in CIE x and CIE y coordinates.

The colour rendering index or CRI is a dimensionless lighting quantity, familiar to the person skilled in the art, which compares the colour reproduction faithfulness of an artificial light source with that of sunlight or filament light sources (the latter two have a CRI of 100).

The CCT or correlated colour temperature is a lighting quantity, familiar to the person skilled in the art, with the unit kelvin. The higher the numerical value, the colder white light from an artificial radiation source appears to the observer. The CCT follows the concept of the black body radiator, whose colour temperature follows a Planckian curve in the CIE diagram.

The lumen equivalent is a lighting quantity, familiar to the person skilled in the art, with the unit lm/W which describes the magnitude of the photometric luminous flux in lumens of a light source at a certain radiometric radiation power with the unit watt. The higher the lumen equivalent, the more efficient a light source.

The lumen is a photometric lighting quantity, familiar to the person skilled in the art, which describes the luminous flux of a light source, which is a measure of the total visible radiation emitted by a radiation source. The greater the luminous flux, the brighter the light source appears to the observer.

CIE x and CIE y stand for the coordinates in the standard CIE colour chart (here standard observer 1931), familiar to the person skilled in the art, by means of which the colour of a light source is described.

All the qualities mentioned above are calculated from emission spectra of the light source by methods familiar to the person skilled in the art.

Preferred mixtures comprise at least one phosphor of the formula I which is characterised in that a stands for a value from the range from 0 to 0.5, preferably from the range 0 to 0.3, and where particularly preferably a=0 to 0.2. Preference is likewise given to mixtures which are characterised in that the mixture comprises at least one phosphor of the formula I where x stands for a value from the range from 0.01 to 0.5, preferably from the range 0.015 to 0.2 and particularly preferably from the range 0.02 to 0.1.

Preference is furthermore given to mixtures which comprise at least one phosphor of the formula I which is characterised in that m stands for a value from the range from 0.05 to 3, preferably from the range 0.1 to 2 and particularly preferably from the range 0.5 to 1.5.

Particular preference is given here to mixtures in which the indices a, x and m represent combinations of the preferred ranges indicated.

Corresponding compounds of the formula I are well known to the person skilled in the art. Thus, the phosphor properties of YAG derivatives which are substituted in various amounts by lutetium and gallium are investigated, for example, in J. M. Robertson, M. W. van Tol, W. H. Smits, J. P. H. Heynen, Philips J. Res. 36 (1981) 15-30.

It is essential to the invention that the mixture comprises at least one red-emitting phosphor.

In the context of this application, red emission or red light denotes light whose intensity maximum is at a wavelength between 610 nm and 670 nm; correspondingly, green denotes light whose maximum is at a wavelength between 508 nm and 550 nm, and yellow denotes light whose maximum is at a wavelength between 551 nm and 585 nm.

The at least one red-emitting phosphor in mixtures which are preferred in accordance with the invention is selected from Ce-doped garnets, Eu-doped thiogallates, Eu-doped sulfoselenides and Eu- and/or Ce-doped nitrides, oxynitrides, alumonitrides and/or Mn(IV)-doped oxides and/or fluorides. It may be particularly preferred for the red-emitting phosphor to be selected from the nitridic phosphors, preferably (Ca,Sr,Ba)₂Si₅N₈:Eu, (Ca,Sr)AlSiN₃:Eu, (Ca,Sr,Ba)SiN₂:Eu, (Ca,Sr,Ba)₆Si₃O₆N₄:Eu, A_{2-0.5y-x}EuₓSi₅N_{8-y}O_{y}, where A stands for one or more elements selected from Ca, Sr, Ba, and x stands for a value from the range from 0.005 to 1 and y stands for a value from the range from 0.01 to 3, or variants of the said compounds in which individual lattice positions are substituted by other chemical elements, such as alkali metals, aluminium, gallium or gadolinium, or further elements of this type occupy flaws as dopant. Material systems which are known to the person skilled in the art and are suitable are siliconitrides and alumosiliconitrides (cf. Xie, Sci. Technol. Adv. Mater. 2007, 8, 588-600): 1-1-2-nitrides, such as, for example, CaSiN₂:Eu²⁺ (Le Toquin, Cheetham, Chem. Phys. Lett. 2006, 423, 352), 2-5-8-nitrides, such as (Ca,Sr,Ba)₂Si₅N₅:Eu²⁺ (Li et al., Chem. Mater. 2005, 15, 4492), and alumosiliconitrides, such as (Ca,Sr)AlSiN₃:Eu²⁺ (K. Uheda et al., Electrochem. Solid State Lett. 2006, 9, H22).

The compound A_{2-0.5y-x}EuₓSi₅N_{8-y}O_{y}, where A stands for one or more elements selected from Ca, Sr, Ba, and x stands for a value from the range from 0.005 to 1 and y stands for a value from the range from 0.01 to 3, is described in patent application EP10000933.1 and is called compound of the formula II below. The compound can be present here as a pure substance or in a mixture with at least one further silicon- and oxygen-containing compound, it being preferred for the at least one further silicon- and oxygen-containing compound to be a reaction by-product of the preparation of the compound of the formula II and for this not to adversely affect the application-relevant optical properties of the compound of the formula II. The invention therefore furthermore relates to a mixture comprising a compound of the formula II, which mixture is obtainable by a process in which, in a step a), suitable starting materials selected from binary nitrides, halides and oxides or corresponding reactive forms thereof are mixed, and, in a step b), the mixture is thermally treated under reductive conditions.

In the compounds of the formula II according to the invention, A in preferred embodiments stands for Sr, while x in preferred embodiments stands for a value from the range from 0.01 to 0.8, preferably from the range 0.02 to 0.7 and particularly preferably from the range 0.05 to 0.6 and very particularly preferably from the range 0.1 to 0.4, and y in preferred embodiments stands for a value from the range from 0.1 to 2.5, preferably from the range 0.2 to 2 and particularly preferably from the range 0.22 to 1.8.

For the preparation of phosphors of the formula II, suitable starting materials selected from binary nitrides, halides and oxides or corresponding reactive forms thereof are mixed in a step a), and the mixture is thermally treated under reductive conditions in a step b). In the above-mentioned thermal treatment, it is preferred for this to be carried out at least partly under reducing conditions. In step b), the reaction is usually carried out at a temperature above 800° C., preferably at a temperature above 1200° C. and particularly preferably in the range 1400° C.-1800° C. The reductive conditions here are established, for example, using carbon monoxide, forming gas or hydrogen or at least vacuum or an oxygen-deficient atmosphere, preferably in a stream of nitrogen, preferably in a stream of N₂/H₂ and particularly preferably in a stream of N₂/H₂/NH₃. If it is intended to prepare the compounds of the formula II in pure form, this can be carried out either via precise control of the starting-material stoichiometry or by mechanical separation of the crystals of the compounds of the formula II from the glass-like fractions. The separation can be carried out, for example, via the different density, particle shape or particle size by separation methods known to the person skilled in the art.

In accordance with the invention, the at least one phosphor of the formula I and the at least one red-emitting phosphor are usually present in the weight ratio 20:1 to 1:1. It is preferred in accordance with the invention for the at least one phosphor of the formula I and the at least one red-emitting phosphor to be present in the weight ratio 10:1 to 3:1 and particularly preferably 6:1 to 4:1.

In a further embodiment, the mixture may additionally comprise at least one further phosphor material from the following: oxides, molybdates, tungstates, vanadates, garnets, silicates, in each case individually or mixtures thereof with one or more activator ions, such as Ce, Eu, Mn, Cr and/or Bi. This is particularly advantageous if certain colour spaces are to be established.

The invention furthermore relates to a process for the preparation of a phosphor mixture in which at least one phosphor of the formula I is mixed with at least one red-emitting phosphor.

The absorption and emission spectrum, the thermal extinction behaviour and the decay time τ_{1/e} of luminescent materials of the formula I are highly dependent on the precise composition of the trivalent cations. The crucial factor for the above-mentioned spectroscopic properties is the crystal field strength of the dodecahedron position on the Ce³⁺ or the covalent character of Ce—O bonds, i.e. the effective negative charge of the oxygen anions and the overlap of the anion and metal orbitals.

The particle size of the phosphors according to the invention is usually between 50 nm and 30 μm, preferably between 1 μm and 20 μm.

In a further preferred embodiment, the phosphors in particle form have a continuous surface coating consisting of SiO₂, TiO₂, Al₂O₃, ZnO, ZrO₂ and/or Y₂O₃ or mixed oxides thereof. This surface coating has the advantage that, through a suitable grading of the refractive indices of the coating materials, the refractive index can be matched to the environment. In this case, the scattering of light at the surface of the phosphor is reduced and a greater proportion of the light can penetrate into the phosphor and be absorbed and converted therein. In addition, the refractive index-matched surface coating enables more light to be coupled out of the phosphor since total internal reflection is reduced.

In addition, a continuous layer is advantageous if the phosphor has to be encapsulated. This may be necessary in order to counter sensitivity of the phosphor or parts thereof to diffusing water or other materials in the immediate environment. A further reason for encapsulation with a closed shell is thermal decoupling of the actual phosphor from the heat generated in the chip. This heat results in a reduction in the fluorescence light yield of the phosphor and may also influence the colour of the fluorescence light. Finally, a coating of this type enables the efficiency of the phosphor to be increased by preventing lattice vibrations arising in the phosphor from propagating to the environment.

In addition, it is preferred for the phosphors to have a porous surface coating consisting of SiO₂, TiO₂, Al₂O₃, ZnO, ZrO₂ and/or Y₂O₃ or mixed oxides thereof or of the phosphor composition. These porous coatings offer the possibility of further reducing the refractive index of a single layer. Porous coatings of this type can be produced by three conventional methods, as described in WO 03/027015, which is incorporated in its full scope into the context of the present application by way of reference: the etching of glass (for example soda-lime glasses (see U.S. Pat. No. 4,019,884)), the application of a porous layer, and the combination of a porous layer and an etching operation.

In a further preferred embodiment, the phosphor particles have a surface which carries functional groups which facilitate chemical bonding to the environment, preferably consisting of epoxy or silicone resin. These functional groups can be, for example, esters or other derivatives which are bonded via oxo groups and are able to form links to constituents of the binders based on epoxides and/or silicones. Surfaces of this type have the advantage that homogeneous incorporation of the phosphors into the binder is facilitated. Furthermore, the rheological properties of the phosphor/binder system and also the pot lives can thereby be adjusted to a certain extent. Processing of the mixtures is thus simplified.

Since the phosphor layer according to the invention applied to the LED chip preferably consists of a mixture of silicone and homogeneous phosphor particles which is applied by bulk casting, and the silicone has a surface tension, this phosphor layer is not uniform on a microscopic level or the thickness of the layer is not constant throughout. This is generally also the case if the phosphor is not applied by the bulk-casting process, but instead in the so-called chip-level conversion process, in which a highly concentrated, thin phosphor layer is applied directly to the surface of the chip with the aid of electrostatic methods.

With the aid of the above-mentioned process, it is possible to produce any desired outer shapes of the phosphor particles, such as spherical particles, flakes and structured materials and ceramics.

The preparation of flake-form phosphors as a further preferred embodiment is carried out by conventional processes from the corresponding metal salts and/or rare-earth salts. The preparation process is described in detail in EP 763573 and DE 102006054331.9, which are incorporated in their full scope into the context of the present application by way of reference. These flake-form phosphors can be prepared by coating a natural or synthetically prepared, highly stable support or a substrate comprising, for example, mica, SiO₂, Al₂O₃, ZrO₂, glass or TiO₂ flakes which has a very large aspect ratio, an atomically smooth surface and an adjustable thickness with a phosphor layer by a precipitation reaction in aqueous dispersion or suspension. Besides mica, ZrO₂, SiO₂, Al₂O₃, glass or TiO₂ or mixtures thereof, the flakes may also consist of the phosphor material itself or be built up from one material. If the flake itself merely serves as support for the phosphor coating, the latter must consist of a material which is transparent to the primary radiation of the LED, or absorbs the primary radiation and transfers this energy to the phosphor layer. The flake-form phosphors are dispersed in a resin (for example silicone or epoxy resin), and this dispersion is applied to the LED chip.

The flake-form phosphors can be prepared on a large industrial scale in thicknesses of 50 nm to about 20 μm, preferably between 150 nm and 5 μm. The diameter here is 50 nm to 20 μm.

It generally has an aspect ratio (ratio of the diameter to the particle thickness) from 1:1 to 400:1 and in particular 3:1 to 100:1.

The flake dimensions (length×width) are dependent on the arrangement. Flakes are also suitable as centres of scattering within the conversion layer, in particular if they have particularly small dimensions.

The surface of the flake-form phosphor according to the invention facing the LED chip can be provided with a coating which has an antireflection action with respect to the primary radiation emitted by the LED chip. This results in a reduction in back-scattering of the primary radiation, enabling the latter to be coupled better into the phosphor body according to the invention.

Suitable for this purpose are, for example, coatings of matched refractive index, which must have a following thickness d: d=[wavelength of the primary radiation of the LED chip/(4*refractive index of the phosphor ceramic)], see, for example, Gerthsen, Physik [Physics], Springer Verlag, 18th Edition, 1995. This coating may also consist of photonic crystals, which also includes structuring of the surface of the flake-form phosphor in order to achieve certain functionalities.

The production of the phosphors according to the invention in the form of ceramic bodies is carried out analogously to the process described in DE 102006037730 (Merck), which is incorporated in its full scope into the context of the present application by way of reference. In this process, the phosphor is prepared by wet-chemical methods by mixing the corresponding starting materials and dopants, subsequently subjected to isostatic pressing and applied directly to the surface of the chip in the form of a homogeneous, thin and non-porous flake. There is thus no location-dependent variation of the excitation and emission of the phosphor, which means that the LED provided therewith emits a homogeneous light cone of constant colour and has high light output. The ceramic phosphor bodies can be produced on a large industrial scale, for example, as flakes in thicknesses of a few 100 nm to about 500 μm. The flake dimensions (length×width) are dependent on the arrangement. In the case of direct application to the chip, the size of the flake should be selected in accordance with the chip dimensions (from about 100 μm*100 μm to several mm²) with a certain oversize of about 10% to 30% of the chip surface with a suitable chip arrangement (for example flip-chip arrangement) or correspondingly. If the phosphor flake is installed over a finished LED, all of the exiting light cone passes through the flake.

The side surfaces of the ceramic phosphor body can be coated with a light metal or noble metal, preferably aluminium or silver. The metal coating has the effect that light does not exit laterally from the phosphor body. Light exiting laterally can reduce the luminous flux to be coupled out of the LED. The metal coating of the ceramic phosphor body is carried out in a process step after the isostatic pressing to give rods or flakes, where the rods or flakes can optionally be cut to the requisite size before the metal coating. To this end, the side surfaces are wetted, for example, with a solution comprising silver nitrate and glucose and subsequently exposed to an ammonia atmosphere at elevated temperature. A silver coating, for example, forms on the side surfaces in the process.

Alternatively, currentless metallisation processes are also suitable, see, for example, Hollemann-Wiberg, Lehrbuch der Anorganischen Chemie [Textbook of Inorganic Chemistry], Walter de Gruyter Verlag or Ullmanns Enzyklopädie der chemischen Technologie [Ullmann's Encyclopaedia of Chemical Technology].

The ceramic phosphor body can, if necessary, be fixed to the baseboard of an LED chip using a water-glass solution.

In a further embodiment, the ceramic phosphor body has a structured (for example pyramidal) surface on the side opposite an LED chip. This enables as much light as possible to be coupled out of the phosphor body. The structured surface on the phosphor body is produced by carrying out the isostatic pressing using a compression mould having a structured pressure plate and thus embossing a structure into the surface. Structured surfaces are desired if the aim is to produce the thinnest possible phosphor bodies or flakes. The pressing conditions are known to the person skilled in the art (see J. Kriegsmann, Technische keramische Werkstoffe [Industrial Ceramic Materials], Chapter 4, Deutscher Wirtschaftsdienst, 1998). It is important that the pressing temperatures used are ⅔ to ⅚ of the melting point of the substance to be pressed.

In addition, the phosphors according to the invention can be excited over a broad range, extending from about 410 nm to 530 nm, preferably 430 nm to about 500 nm. These phosphors are thus not only suitable for excitation by UV- or blue-emitting primary light sources, such as LEDs or conventional discharge lamps (for example based on Hg), but also for light sources such as those which utilise the blue In³⁺ line at 451 nm.

The present invention furthermore relates to a light source having at least one primary light source, characterised in that the light source comprises at least one phosphor of the formula I and at least one red-emitting phosphor. This lighting unit is preferably white-emitting or emits light having a certain colour point (colour-on-demand principle).

In a preferred embodiment of the light source according to the invention, the primary light source is a luminescent indium aluminium gallium nitride, in particular of the formula

InᵢGaⱼAlₖN, where 0≦i,0≦j,0≦k, and i+j+k=1.

In a further preferred embodiment of the light source according to the invention, the primary light source is a luminescent arrangement based on ZnO, TCO (transparent conducting oxide), ZnSe or SiC or an arrangement based on an organic light-emitting layer (OLED).

In a further preferred embodiment of the light source according to the invention, the primary light source is a source which exhibits electroluminescence and/or photoluminescence. The primary light source may furthermore also be a plasma or discharge source.

Possible forms of light sources of this type are known to the person skilled in the art. These can be light-emitting LED chips of various structure.

The phosphors according to the invention can either be dispersed in a resin (for example epoxy or silicone resin) or, in the case of suitable size ratios, arranged directly on the primary light source or alternatively arranged remote therefrom, depending on the application (the latter arrangement also includes “remote phosphor technology”). The advantages of the remote phosphor technology are known to the person skilled in the art and are revealed, for example, by the following publication: Japanese Journ. of Appl. Phys. Vol. 44, No. 21 (2005). L649-L651.

In light sources which are preferred in accordance with the invention, the phosphors are arranged on the primary light source in such a way that the red-emitting phosphor is essentially irradiated by light from the primary light source, while the phosphor of the formula I is essentially irradiated by light which has already passed through the red-emitting phosphor or has been scattered thereby. In a preferred embodiment, this is achieved by the red-emitting phosphor being arranged between the primary light source and the phosphor of the formula I.

The invention furthermore relates to a lighting unit, in particular for the backlighting of display devices, which is characterised in that it comprises at least one light source described above, and to corresponding display devices, in particular liquid-crystal display devices (LC displays), having backlighting, which are characterised in that they comprise at least one lighting unit of this type.

In a further embodiment, it is preferred for the optical coupling of the lighting unit between the phosphor and the primary light source to be achieved by a light-conducting arrangement. This makes it possible for the primary light source to be installed at a central location and to be optically coupled to the phosphor by means of light-conducting devices, such as, for example, optical fibres. In this way, it is possible to achieve lamps adapted to the lighting wishes which merely consist of one or various phosphors, which can be arranged to form a light screen, and an optical waveguide, which is coupled to the primary light source. In this way, it is possible to place a strong primary light source at a location which is favourable for electrical installation and to install lamps comprising phosphors which are coupled to the optical waveguides at any desired locations without further electrical cabling, but instead only by laying optical waveguides.

The present invention furthermore relates to the use of the phosphors according to the invention for the partial or complete conversion of the blue or near-UV emission from a luminescent diode.

Preference is furthermore given to the use of the phosphors according to the invention for the conversion of the blue or near-UV emission into visible white radiation. Preference is furthermore given to the use of the phosphors according to the invention for the conversion of the primary radiation into a certain colour point in accordance with the “colour-on-demand” concept.

The present invention furthermore relates to the use of the phosphors according to the invention in electroluminescent materials, such as, for example, electroluminescent films (also known as lighting films or light films), in which, for example, zinc sulfide or zinc sulfide doped with Mn²⁺, Cu⁺ or Ag⁺ is employed as emitter, which emit in the yellow-green region. The areas of application of the electroluminescent film are, for example, advertising, display backlighting in liquid-crystal display screens (LC displays) and thin-film transistor (TFT) displays, self-illuminating vehicle licence plates, floor graphics (in combination with a crush-resistant and slip-proof laminate), in display and/or control elements, for example in automobiles, trains, ships and aircraft, or also domestic appliances, garden equipment, measuring instruments or sport and leisure equipment.

The following examples are intended to illustrate the present invention. However, they should in no way be regarded as limiting. All compounds or components which can be used in the compositions are either known and commercially available or can be synthesised by known methods. The temperatures indicated in the examples are always in ° C. It furthermore goes without saying that, both in the description and also in the examples, the added amounts of the components in the compositions always add up to a total of 100%. Percentage data given should always be regarded in the given context. However, they usually always relate to the weight of the part-amount or total amount indicated.

Even without further comments, it is assumed that a person skilled in the art will be able to utilise the above description in its broadest scope. The preferred embodiments should therefore merely be regarded as descriptive disclosure which is absolutely not limiting in any way. The complete disclosure content of all applications and publications mentioned above and below is incorporated into this application by way of reference. The following examples are intended to illustrate the present invention. However, they should in no way be regarded as limiting. All compounds or components which can be used in the compositions are either known and commercially available or can be synthesised by known methods.

### EXAMPLES

### Example 1

### Preparation of the Garnet Phosphor

### Example 1A

### Preparation of the Phosphor Lu_{2.91}Al₄GaO₁₂:Ce_{0.09} (“LuGaAG”)

387 g of ammonium hydrogencarbonate are dissolved in 4.3 litres of deionised water over the course of 1 h. 118 g of aluminium chloride hexahydrate, 139 g of lutetium chloride hexahydrate, 3.4 g of cerium chloride heptahydrate and 43.8 g of gallium nitrate are dissolved in 2.7 l of deionised water and added dropwise to the hydrogencarbonate solution over the course of 0.75 h. The hydrogencarbonate solution is adjusted to pH 8. The precipitate formed is filtered off with suction and washed. It is then dried and transferred into an oven. The precipitate is pre-calcined in air at 1100° C. for 3 hours and subsequently subjected to reductive calcination at 1700° C. for 6 hours. The emission spectrum of the compound is shown in FIG. 1.

The following compounds are obtained analogously by suitable modification of the starting-material ratios or by using the additional starting material yttrium chloride hexahydrate:

### Lu_{2.91}Al₄GaO₁₂:Ce_{0.09}

### Lu_{2.95}Al₄GaO₁₂:Ce_{0.05}

### Lu_{2.91}Al₂Ga₃O₁₂:Ce_{0.09}

### Y_{0.3}Lu_{2.61}Al₄GaO₁₂:Ce_{0.09}

### Y_{0.3}Lu_{2.61}Al_{4.5}Ga_{0.5}O₁₂:Ce_{0.09}

### Example 1B

### Preparation of the Phosphor Lu_{2.97}A₅O₁₂:Ce_{0.03} (“LuAG”)

387 g of ammonium hydrogencarbonate are dissolved in 4.3 litres of deionised water over the course of 1 h. 148 g of aluminium chloride hexahydrate, 135 g of lutetium chloride hexahydrate and 0.86 g of cerium chloride heptahydrate are dissolved in 2.7 l of deionised water and added dropwise to the hydrogencarbonate solution over the course of 0.75 h. The hydrogencarbonate solution is adjusted to pH 8. The precipitate formed is filtered off with suction and washed. It is then dried and transferred into an oven.

The precipitate is pre-calcined in air at 1100° C. for 3 hours and subsequently subjected to reductive calcination at 1700° C. for 6 hours. The emission spectrum of the compound is shown in FIG. 1.

### Example 2

### Preparation of the Nitridic Phosphors

### Example 2A

### Preparation of Sr₂Si₅N_{7.666}O_{0.5}:Eu

18.9 g of Sr₃N₂, 0.996 g of EuN, 22.66 g of silicon nitride and 1.504 g of silicon dioxide are weighed out and mixed in a nitrogen-filled glovebox. The resultant mixture is introduced into a boron nitride crucible and transferred into a tubular furnace. The mixture is subsequently calcined under a nitrogen/hydrogen atmosphere at 1600° C. for 8 hours. After cooling, the crude phosphor is removed, ground briefly and again introduced into a molybdenum crucible, which is then transferred into a high-pressure oven, in which the phosphor is calcined again under a nitrogen pressure of 65 bar at 1600° C. for 8 hours. After cooling, the phosphor is removed and suspended in 100 ml of deionised water. The resultant suspension is stirred for 30 minutes, and the stirrer is subsequently switched off. After a few minutes, the supernatant is poured off, and the residue remaining is again taken up in deionised water, filtered off with suction, washed with deionised water until neutral and dried.

### Example 2B

### Preparation of Sr_{1.6}Ca_{0.4}Si₅N_{7.666}O_{0.5}:Eu

19.0 g of Sr₃N₂, 2.47 g of Ca₃N₂, 0.83 g of EuN, 28.33 g of silicon nitride and 1.88 g of silicon dioxide are weighed out and mixed in a nitrogen-filled glovebox. The resultant mixture is introduced into a boron nitride crucible and transferred into a tubular furnace. The mixture is subsequently calcined under a nitrogen/hydrogen atmosphere at 1600° C. for 8 hours. After cooling, the crude phosphor is removed, ground briefly and again introduced into a molybdenum crucible, which is then transferred into a high-pressure oven, in which the phosphor is calcined again under a nitrogen pressure of 65 bar at 1600° C. for 8 hours. After cooling, the phosphor is removed and suspended in 100 ml of deionised water. The resultant suspension is stirred for 30 minutes, and the stirrer is subsequently switched off. After a few minutes, the supernatant is poured off, and the residue remaining is again taken up in deionised water, filtered off with suction, washed with deionised water until neutral and dried.

### Example 2C

### Preparation of Ba₂Si₅N_{7.666}O_{0.5}:Eu

14.446 g of Ba₃N₂, 0.332 g of EuN, 11.33 g of silicon nitride and 0.433 g of silicon dioxide are weighed out and mixed in a nitrogen-filled glovebox. The resultant mixture is introduced into a boron nitride crucible and transferred into a tubular furnace. The mixture is subsequently calcined under a nitrogen/hydrogen atmosphere at 1600° C. for 8 hours. After cooling, the crude phosphor is removed, ground briefly and again introduced into a molybdenum crucible, which is then transferred into a high-pressure oven, in which the phosphor is calcined again under a nitrogen pressure of 65 bar at 1600° C. for 8 hours. After cooling, the phosphor is removed and suspended in 100 ml of deionised water. The resultant suspension is stirred for 30 minutes, and the stirrer is subsequently switched off. After a few minutes, the supernatant is poured off, and the residue remaining is again taken up in deionised water, filtered off with suction, washed with deionised water until neutral and dried.

### Example 2D

### Preparation of the Phosphor Sr₂Si₅N₈:Eu

1.84 g of Sr₃N₂, 0.166 g of EuN and 2.33 g of silicon nitride are weighed out and mixed in a nitrogen-filled glovebox. The resultant mixture is introduced into a boron nitride crucible and transferred into a tubular furnace. The mixture is subsequently calcined under a nitrogen/hydrogen atmosphere at 1600° C. for 8 hours. After cooling, the crude phosphor is removed, ground briefly and again introduced into a molybdenum crucible, which is then transferred into a high-pressure oven, in which the phosphor is calcined again under a nitrogen pressure of 65 bar at 1600° C. for 8 hours. After cooling, the phosphor is removed and suspended in 100 ml of deionised water. The resultant suspension is stirred for 30 minutes, and the stirrer is subsequently switched off. After a few minutes, the supernatant is poured off, and the residue remaining is again taken up in deionised water, filtered off with suction, washed with deionised water until neutral and dried.

### Example 2E

### Preparation of the Phosphor (Sr, Ca)AlSiN₃:Eu

2.22 g of Sr₃N₂, 0.33 g of Ca₃N₂, 0.05 g of EuN, 1.23 g of AlN and 1.4 g of silicon nitride are weighed out and mixed in a nitrogen-filled glovebox. The resultant mixture is introduced into a boron nitride crucible and transferred into a hot isostatic press. A nitrogen pressure of 500 bar was established, and the mataerial was subsequently heated to 1700° C. and conditioned at this temperature for 4 hours; during this process, the pressure increased to 1740 bar. After cooling and ventilation, the material was removed and suspended in 100 ml of deionised water. The resultant suspension is stirred for 30 minutes, and the stirrer is subsequently switched off. After a few minutes, the supernatant is poured off, and the residue remaining is again taken up in deionised water, filtered off with suction, washed with deionised water until neutral and dried.

### Example 3

### Preparation of the Phosphor Mixtures

### Example 3.1

### “LuAG—Nitride”

10 g of the phosphor from Example 1B are mixed intimately with 1 g of the phosphor from Example 2D.

A mixture comprising the phosphors from Examples 1B and 2A or 1B and 2B or 1B and 2C or 1B and 2E is prepared analogously.

### Example 3.2

### “LuGaAG—Nitride”

6 g of the LuGaAG phosphor from Example 1A are mixed intimately with 1 g of the phosphor from Example 2A.

A mixture comprising the phosphors from Examples 1A and 2B or 1A and 2C or 1A and 2D or 1A and 2E is prepared analogously.

### Example 4

### Production of a Light-Emitting Diode (“LuAG—Nitride”)

The phosphor mixture from Example 3.1 is mixed with a 2-component silicone (OE 6550 from Dow Corning) in a tumble mixer in such a way that equal amounts of the phosphor mixture are dispersed in the two components of the silicone; the total concentration of the phosphor mixture in the silicone is 8% by weight.

5 ml of each of the two phosphor-containing silicone components are mixed homogeneously with one another and transferred into a dispenser. Empty LED packages from OSA optoelectronics, Berlin, which contain a 100 μm² GaN chip are filled with the aid of the dispenser. The LEDs are then placed in a heat chamber in order to solidify the silicone over 1 h at 150° C.

### Example 5

### Production of a Light-Emitting Diode (“LuGaAG—Nitride”)

The phosphor mixture from Example 3.2 is mixed with a 2-component silicone (OE 6550 from Dow Corning) in a tumble mixer in such a way that equal amounts of the phosphor mixture are dispersed in the two components of the silicone; the total concentration of the phosphor mixture in the silicone is 5% by weight.

5 ml of each of the two phosphor-containing silicone components are mixed homogeneously with one another and transferred into a dispenser. Empty LED packages from OSA optoelectronics, Berlin, which contain a 100 μm² GaN chip are filled with the aid of the dispenser. The LEDs are then placed in a heat chamber in order to solidify the silicone over 1 h at 150° C.

The emission spectra of the two LEDs from Examples 4 and 5 are shown in FIG. 2. The two LEDs have approximately identical characteristic values:

| | CRI | CCT | Lumen equivalent | Lumen | CIE x | CIE y |
|---|---|---|---|---|---|---|
| Ex. 5 | 96.0 | 3145.0 | 279.23 | 3.63 | 0.4259 | 0.3979 |
| Ex. 4 | 97.0 | 3262.0 | 270.77 | 3.52 | 0.4179 | 0.3937 |

“CRI” stands for the “colour rendering index”, which is a dimensionless lighting quantity, familiar to the person skilled in the art, which compares the colour reproduction faithfulness of an artificial light source with that of sunlight or filament light sources (the latter two have a CRI of 100).

“CCT” stands for the “correlated colour temperature”, which is a lighting quantity, familiar to the person skilled in the art, with the unit kelvin. The higher the numerical value, the colder white light from an artificial light source appears to the observer. The CCT follows the concept of the black body radiator, whose colour temperature follows a Planckian curve in the CIE diagram.

The lumen equivalent is a lighting quantity, familiar to the person skilled in the art, with the unit lm/W which describes the magnitude of the photometric luminous flux in lumens of a light source at a certain radiometric radiation power with the unit watt. The higher the lumen equivalent, the more efficient a light source.

The lumen is a photometric lighting quantity, familiar to the person skilled in the art, which describes the luminous flux of a light source, which is a measure of the total visible radiation emitted by a radiation source. The greater the luminous flux, the brighter the light source appears to the observer.

CIE x and CIE y stand for the coordinates in the standard CIE colour chart (here standard observer 1931), familiar to the person skilled in the art, by means of which the colour of a light source is described. All the quantities mentioned above are calculated from emission spectra of the light source by methods familiar to the person skilled in the art.

The composition of the phosphor mixture in the LED “LuAG—nitride” is 10 parts by weight of LuAG LGA 553 100:1 part by weight of nitride. The concentration of the phosphor mixture in the LED is 8% by weight (in the silicone). The composition of the phosphor mixture in the LED “LuGaAG—nitride” is 6 parts by weight of LuGaAG:1 part by weight of nitride. The concentration of the phosphor mixture in the LED is 5% by weight (in the silicone), i.e. virtually identical LED characteristic values are obtained in spite of a lower phosphor use concentration (here: LuGaAG concentration).

### Example 6

### Production of a Light-Emitting Diode in which the Phosphors are Arranged on the Primary Light Source in Such a Way that the Red-Emitting Phosphor is Essentially Irradiated by Light from the Primary Light Source, while the Green-Emitting Phosphor is Essentially Irradiated by Light which has Already Passed Through the Red-Emitting Phosphor or has been Scattered Thereby

The phosphor from Example 1A or the phosphor from Example 1B is mixed with a 2-component silicone (OE 6550 from Dow Corning) in a tumble mixer in such a way that equal amounts of the phosphor mixture are dispersed in the two components of the silicone. The concentration of the green phosphor in the silicone is 5% by weight of LuGaAG (premix A1) or 8% by weight of LuAG (premix A2).

The red-emitting phosphor from Example 2A or 2B or 2C is in each case mixed with a 2-component silicone (OE 6550 from Dow Corning) in a tumble mixer in such a way that equal amounts of the phosphor mixture are dispersed in the two components of the silicone. The concentration of the red phosphor in the silicone is 1% by weight (premix B1—premix B3).

5 ml of each of the two phosphor-containing silicone components of a premix are mixed homogeneously with one another and transferred into a dispenser. Empty LED packages from OSA optoelectronics, Berlin, which contain a 100 μm² GaN chip are filled with the aid of the dispenser. Premix B is introduced first, and the LEDs are subsequently placed in a heat chamber in order to solidify the silicone over 1 h at 150° C. Premix A (A1 or A2) is then introduced, and the LEDs are again placed in a heat chamber in order to solidify the silicone over 1 h at 150° C.

### DESCRIPTION OF THE FIGURES

FIG. 1: The emission spectra of a weakly doped LuAG from Example 2 (continuous line, peak at 525 nm) and the emission curve of a highly doped LuGaAG from Example 1 have approximately the same colour properties. (The emission measurement was carried out on an optically infinitely thick layer of the phosphor with excitation at 450 nm using an Edinburgh Instruments OC290 spectrometer at room temperature.)

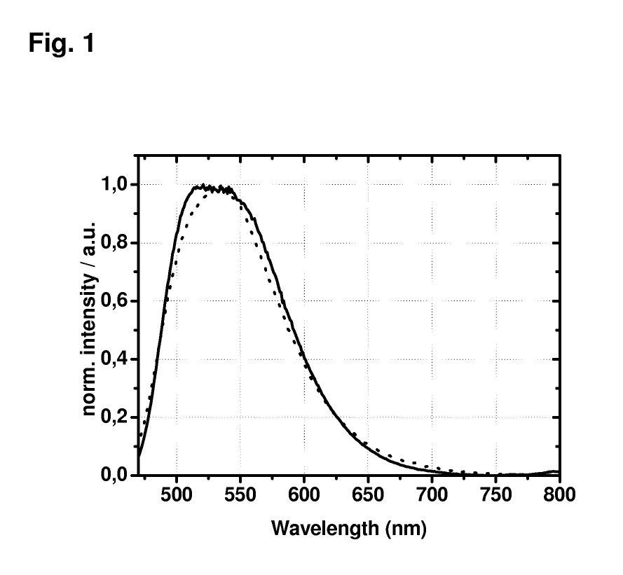

FIG. 2: Emission spectra of the light-emitting diodes from Examples 4 and 5 The continuous line represents the LED from Comparative Example 4 (proportions by weight of LuAG:nitride=10:1). The dashed line represents an LED in accordance with Example 5 which has been constructed with the phosphor mixture consisting of LuGaAG:Ce and a 2-5-8 nitride emitting at 638 nm (proportions by weight of LuGaAG:nitride=6:1). (The emission measurement was carried out using an Instrument Systems CAS 140 spectrometer in an Instrument Systems ISP 250 integration sphere with the aid of a Keithley model 2601 power source. The LED was continuously addressed with 20 mA stabilised at room temperature.)

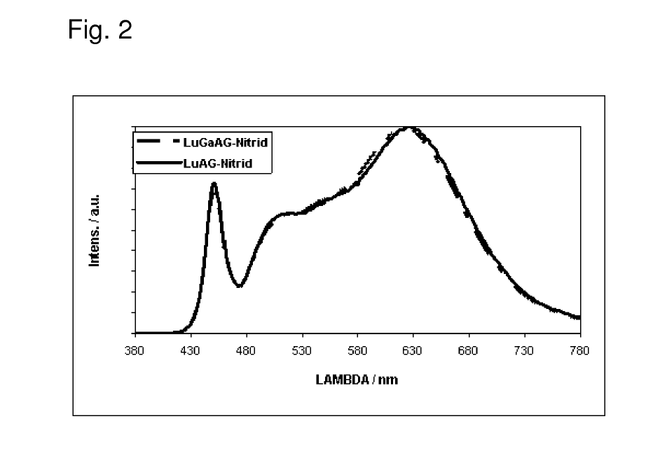

1. Mixture comprising at least one phosphor of the formula I,
AₐLu_{c},CeₓAlₗ,GaₘO₁₂ (I)
where
A stands for one or more elements selected from Y, Gd, Se, Sm, Tb, Pr, Th, Ir, Sb, Bi, and
a stands for a value from the range from 0 to 2.895 and
c stands for a value from the range from 0.1 to 2.995 and
x stands for a value from the range from 0.005 to 1 and
where a, c and x are selected so that a+c+x=3, and
l stands for a value from the range from 0 to 4.99 and
m stands for a value from the range from 0.01 to 5, where l and m are selected so that l+m=5, and
at least one red-emitting phosphor.

2. Mixture according to claim 1, characterised in that the mixture comprises at least one phosphor of the formula I which is characterised in that a stands for a value from the range from 0 to 0.5, preferably from the range 0 to 0.3, and where particularly preferably a=0 to 0.2.

3. Mixture according to claim 1, characterised in that the mixture comprises at least one phosphor of the formula I which is characterised in that x stands for a value from the range from 0.01 to 0.5, preferably from the range 0.015 to 0.2 and particularly preferably from the range 0.02 to 0.1.

4. Mixture according to claim 1, characterised in that the mixture comprises at least one phosphor of the formula I which is characterised in that m stands for a value from the range from 0.05 to 3, preferably from the range 0.1 to 2 and particularly preferably from the range 0.5 to 1.5.

5. Mixture according to claim 1, characterised in that at least one red-emitting phosphor is selected from Ce-doped garnets, Eu-doped thiogallates, Eu-doped sulfoselenides and Eu- and/or Ce-doped nitrides, oxynitrides, alumonitrides and/or Mn(IV)-doped oxides and/or fluorides.

6. Mixture according to claim 1, characterised in that at least one red-emitting phosphor is selected from the nitridic phosphors, preferably (Ca,Sr,Ba)₂Si₅N₈:Eu, (Ca,Sr)AlSiN₃:Eu, (Ca,Sr,Ba)SiN₂:Eu, (Ca,Sr,Ba)₆Si₃O₆N₄:Eu, (Ca,Sr,Ba)_{2-x/2}Si₅N₈₋ₓOₓ:Eu, where x stands for a number from the range 0.01 to 3, or variants of the said compounds in which individual lattice positions are substituted by other chemical elements, such as alkali metals, aluminium, gallium or gadolinium, or further elements of this type occupy flaws as dopant.

7. Mixture according to claim 1, characterised in that the at least one phosphor of the formula I and the at least one red-emitting phosphor are present in the weight ratio 20:1 to 1:1, preferably 10:1 to 3:1 and particularly preferably 6:1 to 4:1.

8. Process for the preparation of a phosphor mixture according to claim 1, characterised in that at least one phosphor of the formula I is mixed with at least one red-emitting phosphor.

9. Light source having at least one primary light source, characterised in that the light source comprises at least one phosphor of the formula I according to claim 1 and at least one red-emitting phosphor.

10. Light source according to claim 9, characterised in that the primary light source is a luminescent indium aluminium gallium nitride, in particular of the formula
InᵢGaⱼAlₖN, where 0≦i,0≦j,0≦k, and i+j+k=1.

11. Light source according to claim 9, characterised in that the phosphors are arranged on the primary light source in such a way that the red-emitting phosphor is essentially irradiated by light from the primary light source, while the phosphor of the formula I is essentially irradiated by light which has already passed through the red-emitting phosphor or has been scattered thereby.

12. Light source according to claim 11, characterised in that the red-emitting phosphor is arranged between the primary light source and the phosphor of the formula I.

13. Lighting unit, in particular for the backlighting of display devices, characterised in that it comprises at least one light source according to claim 9.

14. Lighting unit according to claim 13, characterised in that the optical coupling between the phosphor and the primary light source is achieved by a light-conducting arrangement.

15. Display device, in particular liquid-crystal display device (LC display), having backlighting, characterised in that it comprises at least one lighting unit according to claim 13.

16. Use of a mixture according to claim 1 as conversion phosphor for the partial or complete conversion of the blue or near-UV emission from a luminescent diode.

17. A method for the partial or complete conversion of the blue or near-UV emission from a luminescent diode by converting the phosphor with a mixture according to claim 1.
